(19) United States
(12) Patent Application Publication
(10) Pub. No.: US 2016/0012371 A1
(43) Pub. Date: Jan. 14, 2016

(54) METHOD AND SYSTEM FOR ASSESSING OILFIELD SERVICES

(71) Applicant: Schlumberger Technology Corporation, Sugar Land, TX (US)

(72) Inventors: Mark S. Passolt, Hansville, WA (US); Velizar Vesselinov, Menlo Park, CA (US); Matias Nicolas Rodriguez, Concord, CA (US)

(21) Appl. No.: 14/795,732

(22) Filed: Jul. 9, 2015

Related U.S. Application Data
(60) Provisional application No. 62/023,641, filed on Jul. 11, 2014.

(51) Int. Cl. G06Q 10/06

(52) U.S. Cl. CPC G06Q 10/06393

(57) ABSTRACT

A method may include selecting various activities for determining an assessment. The method may further include obtaining activity data regarding the selected activities. The activity data may describe the performance of a portion of the selected activities. The method may further include identifying, using the activity data, various completed activities from the selected activities. The method may further include computing, using various scoring parameters, various activity scores from the completed activities. The scoring parameters may determine the activity scores based on a contribution of the completed activities towards the assessment. The method may further include computing an assessment score based on the activity scores. The method may further include generating, using the assessment score, an assessment report. The method may further include transmitting the assessment report.

### CROSS-REFERENCE TO RELATED APPLICATIONS

This application claims priority to U.S. Provisional Patent Application Ser. No. 62/023,641, which was filed on Jul. 11, 2014, and is incorporated herein by reference.

### BACKGROUND

Hydrocarbon fluids such as oil and natural gas are obtained from a subterranean geologic formation, referred to as a reservoir, by drilling a well that penetrates the hydrocarbon-bearing formation. Before drilling the well, various studies may be performed to determine both the costs and design specifications entailed in drilling a wellbore. Once the wellbore is drilled, various forms of well completion components may be installed to control and enhance the efficiency of producing various fluids from the reservoir.

### SUMMARY

In general, in one aspect, embodiments relate to a method. The method includes selecting various activities for determining an assessment. The method further includes obtaining activity data regarding the selected activities. The activity data describes the performance of a portion of the selected activities. The method further includes identifying, using the activity data, various completed activities from the selected activities. The method further includes computing, using various scoring parameters, various activity scores from the completed activities. The scoring parameters determine the activity scores based on a contribution of the completed activities towards the assessment. The method further includes computing an assessment score based on the activity scores. The method further includes generating, using the assessment score, an assessment report. The method further includes transmitting the assessment report.

Other aspects of the technology will be apparent from the following description and the appended claims.

### BRIEF DESCRIPTION OF DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein.

FIGS. 1 and 2 show schematic diagrams in accordance with one or more embodiments of the technology.

FIG. 3 shows a computing system in accordance with one or more embodiments of the technology.

FIGS. 4-6 show flowcharts in accordance with one or more embodiments of the technology.

FIGS. 7.1-7.4 show an example in accordance with one or more embodiments of the technology.

### DETAILED DESCRIPTION

Specific embodiments of the technology will now be described in detail with reference to the accompanying figures. Like elements in the various figures are denoted by like reference numerals for consistency.

In the following detailed description of embodiments of the technology, numerous specific details are set forth in order to provide a more thorough understanding of the technology. However, it will be apparent to one of ordinary skill in the art that the technology may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the technology include a method, a system, and a non-transitory computer readable medium for performing various assessments. In particular, one or more embodiments are directed to computing a maturity assessment for an oilfield services proposal. As such, various activities for proposal creation may be identified as complete and various activity scores may be computed for each completed activity. A maturity assessment score may be computed from the activity scores and used to generate an assessment report. As such, the assessment report may be transmitted to various entities notifying them regarding an amount of progress made towards the oilfield services proposal. In one or more embodiments, a skill assessment on an oilfield services worker is performed using a similar method.

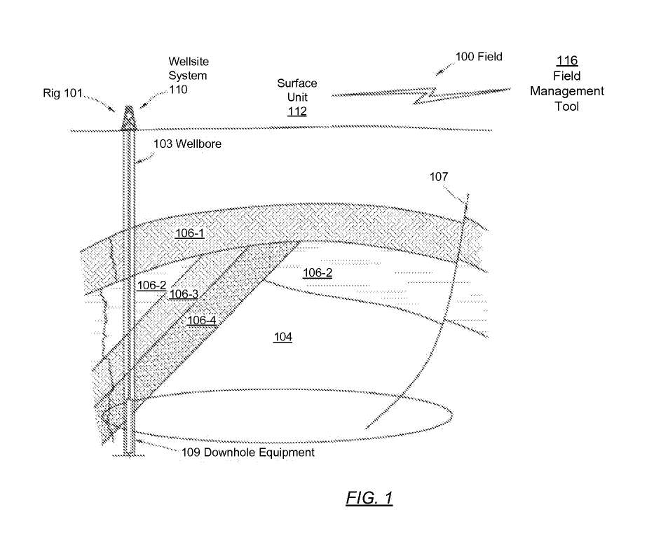

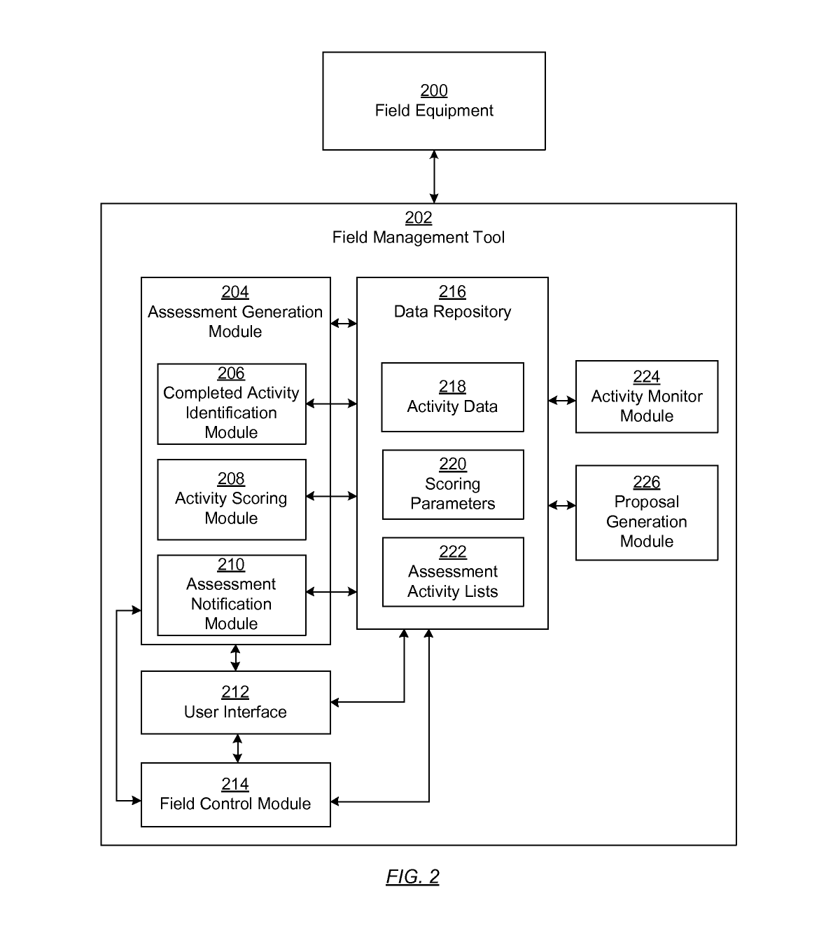

FIG. 1 depicts a schematic view, partially in cross section, of a field (100) in which one or more embodiments may be implemented. In one or more embodiments, the field may be an oilfield. In other embodiments, the field may be a different type of field. In one or more embodiments, one or more of the modules and elements shown in FIG. 1 may be omitted, repeated, and/or substituted. Accordingly, embodiments should not be considered limited to the specific arrangements of modules shown in FIG. 1.

As shown in FIG. 1, the subterranean formation (104) may include several geological structures (106-1 through 106-4) of which FIG. 1 provides an example. As shown, the formation may include a sandstone layer (106-1), a limestone layer (106-2), a shale layer (106-3), and a sand layer (106-4). A fault line (107) may extend through the formation. In one or more embodiments, various survey tools and/or data acquisition tools are adapted to measure the formation and detect the characteristics of the geological structures of the formation. Further, as shown in FIG. 1, the wellsite system (110) is associated with a rig (101), a wellbore (103), and other field equipment and is configured to perform wellbore operations, such as logging, drilling, fracturing, production, or other applicable operations. The wellbore (103) may also be referred to as a borehole.

In one or more embodiments, the surface unit (112) is operatively coupled to a field management tool (116) and/or the wellsite system (110). In particular, the surface unit (112) is configured to communicate with the field management tool (116) and/or the wellsite system (110) to send commands to the field management tool (116) and/or the wellsite system (110) and to receive data therefrom. For example, the wellsite system (110) may be adapted for measuring downhole properties using logging-while-drilling (“LWD”) tools to obtain well logs and for obtaining core samples. In one or more embodiments, the surface unit (112) may be located at the wellsite system (110) and/or remote locations. The surface unit (112) may be provided with computer facilities for receiving, storing, processing, and/or analyzing data from the field management tool (116), the wellsite system (110), or another part of the field (100). The surface unit (112) may also be provided with or functionally for actuating mechanisms at the field (100). The surface unit (112) may then send command signals to the field (100) in response to data received, for example, to control and/or optimize various field operations described above.

During the various oilfield operations at the field, data is collected for analysis and/or monitoring of the oilfield operations. Such data may include, for example, subterranean formation, equipment, historical and/or other data. Static data relates to, for example, formation structure and geological stratigraphy that define the geological structures of the subterranean formation. Static data may also include data about the wellbore, such as inside diameters, outside diameters, and depths. Dynamic data relates to, for example, fluids flowing through the geologic structures of the subterranean formation over time. The dynamic data may include, for example, pressures, fluid compositions (e.g. gas oil ratio, water cut, and/or other fluid compositional information), choke positions of down hole flow control valves, and other information that may be monitored via downhole equipment (109) such as downhole sensors. The downhole sensors may include sensors which are part of the down hole flow control valves and sensors, e.g. pressure and temperature sensors, which are located separately in the various well zones and/or other well locations.

The static and dynamic data collected from the wellbore and the oilfield may be used to create and update a three dimensional model of the subsurface formations. Additionally, static and dynamic data from other wellbores or oilfields may be used to create and update the three dimensional model. Hardware sensors, core sampling, and well logging techniques may be used to collect the data. Other static measurements may be gathered using downhole measurements, such as core sampling and well logging techniques. Well logging involves deployment of a downhole tool into the wellbore to collect various downhole measurements, such as density, resistivity, etc., at various depths. Such well logging may be performed using, for example, a drilling tool and/or a wireline tool, or sensors located on downhole production equipment. Once the well is formed and completed, fluid flows to the surface using production tubing and other completion equipment. As fluid passes to the surface, various dynamic measurements such as fluid flow rates, pressure, and composition may be monitored. These parameters may be used to determine various characteristics of the subterranean formation.

In one or more embodiments, the data is received by the surface unit (112), which is communicatively coupled to the field management tool (116). Generally, the field management tool (116) is configured to analyze, model, control, optimize, or perform other management tasks of the aforementioned field operations based on the data provided from the surface unit (112). Although the surface unit (112) is shown as separate from the field management tool (116) in FIG. 1, in other examples, the surface unit (112) and the field management tool (116) may also be combined.

In the vertical well shown in FIG. 1, a lateral of the vertical well is the borehole. Although FIG. 1 shows a vertical well, one or more embodiments may apply to a horizontal well and/or a multilateral well that extends horizontally through one or more subsurface formations. For example, in a horizontal well, the lateral may correspond to the single borehole trajectory. The single lateral of the horizontal or vertical well may have multiple zones isolated by packers and down hole flow control valves. In a multilateral well, multiple laterals may exist.

FIG. 2 shows a schematic diagram of a system in accordance with one or more embodiments of the technology. In FIG. 2, lines represent operable connections between components. In other words, the operable connections represent at least some of the components that may share data and commands. The operable connections may be direct or indirect, through a network, through shared storage, through application programming interface calls, intermittent or semi-permanent, or through any other type of connection. As shown in FIG. 2, field equipment (200) is operatively connected to a field management tool (202). The field equipment (200) may correspond to any of the hardware and other equipment discussed above with reference to FIG. 1. The field management tool (202) may correspond to the field management tool discussed above with reference to FIG. 1. While the field management tool (202) is describes in use with various activities relating to drilling in FIG. 1, the field management tool (202) may further be used with respect to various activities in preparation to drilling, e.g., surveying a possible wellsite. Thus, the field management tool (202) may be used with respect to activities performed prior to actual drilling.

As shown in FIG. 2, the field management tool (202) includes an assessment generation module (204), a user interface (212), a field control module (214), a data repository (216), an activity monitor module (224), and a proposal generation module (226). Each of these components is described below.

In one or more embodiments, the assessment generation module (204) corresponds to hardware, software, firmware, or a combination thereof that includes functionality to generate an assessment based on at least one completed activity. In one or more embodiments, the assessment generation module (204) may generate an assessment when no activities have been completed. In one or more embodiments, an activity is one or more tasks performed by a person or group and/or electronic device(s), which produces a specific output for a particular project (e.g., an oilfield services project). For example, designing a drilling specification may include a set of tasks where the actual drilling specification is the output. An activity may be independent or dependent on other activities. For example, activities of one department may be dependent on other activities in the department while being independent of activities of another department. Thus, activities may be performed in a variety of orders and in parallel in some embodiments. A completed activity is an activity that is completely performed and has a corresponding result. The assessment may be an analysis of the completed activities with respect to the particular project, e.g., the potential success of the project or an estimated date of completion of the project. In one or more embodiments, the assessment generation module (204) generates an assessment using various activities still in progress of being completed. Thus, a partially complete activity (i.e., an activity having a portion of the tasks complete for the activity) may be used in place of a completed activity by the assessment generation module (204).

In one or more embodiments, for example, an assessment is a maturity assessment regarding an oilfield services proposal. Thus, a client or potential client may request a bid for an oilfield services project, such as the construction of an oil, gas, or water well. In response to the request, an oilfield services proposal (also called proposal for oilfield services (PFOS)) may be generated that describes various details in performing the project, such as associated costs, a schedule for completing the project, and other details describing the bid. The maturity assessment may determine a degree of progress by various persons and/or organizations based on various completed activities, such as performing or reviewing a mud specification, trajectory specification, etc. In one or more embodiments, the assessment is a skill assessment of an oilfield services worker based on one or more activities completed by the oilfield services worker. Examples of the activities for the skill assessment may be similar to the activities used in a maturity assessment regarding an oilfield services proposal.

In one or more embodiments, the assessment generation module (204) includes a completed activity identification module (206), an activity scoring module (208), and an assessment notification module (210). The completed activity identification module (206) may be configured to detect when activities are completed for performing an assessment. As such, the completed activity identification module (206) may be configured to detect other characteristics of a completed activity such as when the completed activity is performed, and what person and/or organization performed the completed activity. In one or more embodiments, the activity scoring module (208) is configured to determine one or more point values for one or more activities based on various scoring parameters. In one or more embodiments, the activity scoring module (208) is configured to determine an aggregate assessment score, such as a maturity assessment score or a skill assessment score, according to a combination of activity scores for various completed activities. The assessment notification module (210) may be configured to generate an assessment report describing the maturity of an oilfield services proposal or information relating to the skills and behaviors of a person and/or organization. The proposal generation module (226) may be configured to generate an oilfield services proposal using data collected from various completed activities. While the completed activity identification module (206), the activity scoring module (208), and the assessment notification module (210) are shown located in the assessment generation module (204) in FIG. 2, each module may be located outside the assessment generation module (204).

In one or more embodiments, the data repository (216) is any type of storage unit and/or device (e.g., a file system, database, collection of tables, or any other storage mechanism) for storing data. Further, the data repository (216) may include multiple different storage units and/or devices. The multiple different storage units and/or devices may or may not be of the same type or located at the same physical site.

The data repository (216) includes functionality to store activity data (218), scoring parameters (220), assessment activity lists (222), and design specifications (not shown) in accordance with one or more embodiments. The activity data (218) may include information regarding the performance of an activity, and may include data showing whether an activity has been performed.

For example, activity data (218) may include designs (electronic or physical) activities, design activity data obtained using the proposal generation module (226) (e.g., trajectory design), and engineering reports approving or rejecting a particular design specification, and/or notifications (e.g., an email message) that a task or set of tasks relating to an activity have been performed. As such, the activity data (218) may include direct data showing the direct occurrence of an activity (i.e., an automated message from the proposal generation module (226) stating that the activity was performed at a particular date and time) and/or indirect data (e.g., paper design document with approval signature) pointing to the occurrence of the activity (e.g., a design document suggests that an analysis was performed).

In one or more embodiments, the activity monitor module (224) identifies completed activities using the activity data (218). Thus, the activity monitor module (224) may track the performance of tasks associated with an activity to determine whether an activity is partially complete or fully complete.

In one or more embodiments, the scoring parameters (220) assign various amounts of points towards an activity score based upon the completion of an activity. As such, the scoring parameters (220) may assign scalar point values for an activity based on whether an activity exists in a “done” or “not done” state (i.e., similar to a checklist). In one or more embodiments, the scoring parameters (220) assign points as a vector, thus producing activity scores for a multi-dimensional assessment. In other words, the vector maintains the association of the assigned score by a scoring parameter to an activity.

In one or more embodiments, scoring parameters (220) are each defined for a unique objective for the activities. In other words, each scoring parameter defines a mapping of activities to corresponding points based on contribution of the activity to the corresponding objective for the activities. By way of an example, a first scoring parameter may define a first mapping of activities to a first set of corresponding points for a first objective of the activities. In the example, a second scoring parameter, that is independent of the first, may define a second mapping of the same and/or different activities to a second set of corresponding points for a second objective of the activities. Each objective of the activities is a particular sub-goal for the assessment. The mapping assigns points based on the degree to which the activity being completed indicates achievement of the sub-goal. In other words, the mapping defines the amount of contribution (including possible negative contribution) of the completed activity to the sub-goal.

In one or more embodiments, the scoring parameters (220) include a technical quality parameter. The technical quality parameter is for an objective of a certain technical quality (e.g., high technical quality). The technical quality parameter defines a mapping of completed activities to scores indicating the degree in which completion of the activity indicates an increase or decrease in the technical quality. For example, the technical quality parameter may define the amount of points assigned towards the assessment score based on the type of person and/or organization that performed the activity. For example, a technical quality parameter may correspond to the experience and qualifications of an engineer, such as whether he/she is a junior engineer, a senior engineer, or a regular engineer. As such, the technical quality parameter may designate a senior engineer for a designated activity as garnering more points than a junior engineer performing the same activity. In one or more embodiments, the technical quality parameter assigns an amount of points based on a relative value of the completed activity in relation to other activities for a particular project. Thus, a mandatory activity may have a technical quality parameter that assigns more points than an optional activity.

In one or more embodiments, the scoring parameters (220) may include a timing attribute that further partitions points based on the time when an activity is performed. In particular, timing attributes may change the assignment of points to a completed activity based on when the activity, relative to when other activities, are performed. Thus, timing attributes may produce a dynamic assessment that changes depending on the order that activities are completed. For example, a timing attribute may assign points using the date or time-of-day that an activity is completed. In one or more embodiments, a timing attribute assigns points based on which other activities are complete or remain incomplete at a particular activity's time of completion. In one or more embodiments, for example, a different point value is computed for a completed activity when the same completed activity is performed at a different stage in generating an oilfield services proposal. For another example, an activity may include an engineer generating a bottom hole assembly (BHA) design specification, while other activities may include reviewing and approving the BHA design specification. As such, a timing attribute may specify that if the BHA design specification is reviewed before the BHA design specification is approved, then the BHA specification review generates a higher point total than if the BHA specification is reviewed after the BHA is already approved.

In one or more embodiments, the scoring parameters (220) include a component parameter in regard to a particular activity. The component parameter assigns points based on the degree to which completion of the each activity contributes to the goal of completing the project. Specifically, the project may be divided into a specific number of elements or components. Thus, a component parameter may assign points based on an amount of progress achieved by the activity towards completing the project being assessed. Further, the component parameter may assign a point amount associated with the percentage of components produced by the activity for completing the assessment.

In one or more embodiments, assessment activity lists (222) include different types of activities available for performing various types of assessment. Thus, when selecting activities for a particular assessment, the assessment activity lists (222) may provide a predefined pool of activities from where the selected activities may be chosen. In one or more embodiments, a particular type of assessment has a corresponding assessment activity list for automatically determining which activities may be included in the assessment.

In one or more embodiments, the data repository (216) and the assessment generation module (204) are operably connected to a field control module (214). The field control module (214) may include functionality to collect data from a wellsite and perform various tests on the wellsite. In one or more embodiments, the field control module (214) may further include functionality to obtain results of processing and send commands to the field equipment. In other words, the field control module (214) may include functionality to control the equipment at the field, with or without human interaction.

In one or more embodiments, the user interface (212) is connected to the field control module (214), and may be configured to interact with a user. For example, the user interface (212) may be a graphical user interface. Further, the user interface (212) may include functionality to receive information about activity data (218), completed activity lists (222), scoring parameters (220), design specifications, and/or various field operations. The user interface (212) may further be configured to display output of the assessment generation module (204), the activity identification module (206), the assessment notification module (210), the field control module (214), or a combination thereof.

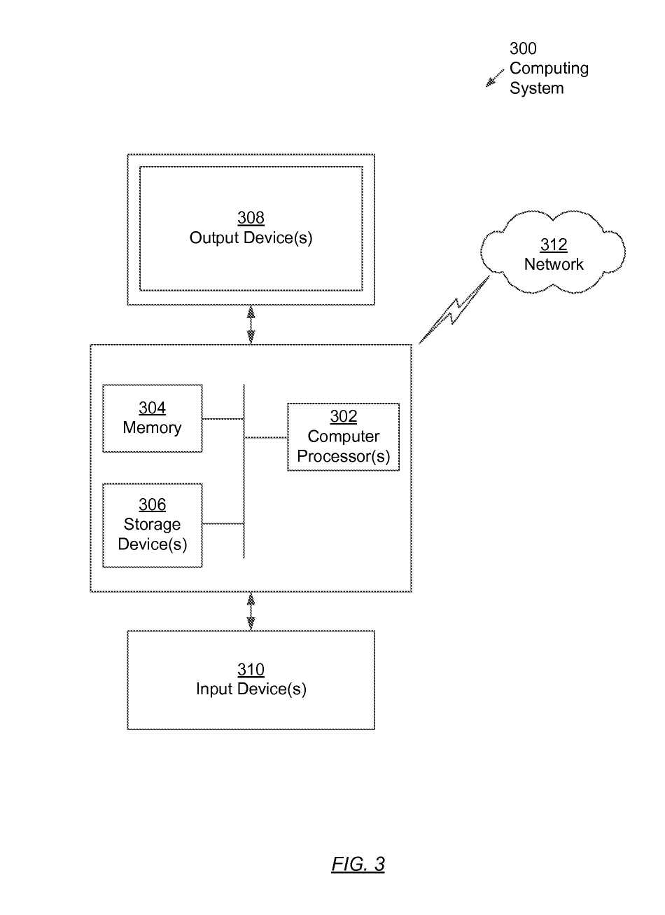

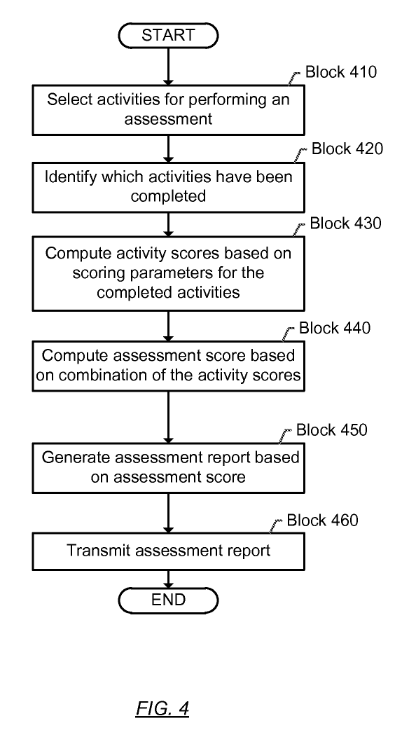

Embodiments of the technology may be implemented on a computing system. Any combination of mobile, desktop, server, embedded, or other types of hardware may be used. For example, as shown in FIG. 3, the computing system (300) may include one or more computer processor(s) (302), associated memory (304) (e.g., random access memory (RAM), cache memory, flash memory, etc.), one or more storage device(s) (306) (e.g., a hard disk, an optical drive such as a compact disk (CD) drive or digital versatile disk (DVD) drive, a flash memory stick, etc.), and numerous other elements and functionalities. The computer processor(s) (302) may be an integrated circuit for processing instructions. For example, the computer processor(s) may be one or more cores, or micro-cores of a processor. The computing system (300) may also include one or more input device(s) (310), such as a touchscreen, keyboard, mouse, microphone, touchpad, electronic pen, or any other type of input device. Further, the computing system (300) may include one or more output device(s) (308), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (300) may be connected to a network (312) (e.g., a local area network (LAN), a wide area network (WAN) such as the Internet, mobile network, or any other type of network) via a network interface connection (not shown). The input and output device(s) may be locally or remotely (e.g., via the network (312)) connected to the computer processor(s) (302), memory (304), and storage device(s) (306). Many different types of computing systems exist, and the aforementioned input and output device(s) may take other forms.

Software instructions in the form of computer readable program code to perform embodiments of the technology may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the technology.

Further, one or more elements of the aforementioned computing system (300) may be located at a remote location and connected to the other elements over a network (312). Further, embodiments of the technology may be implemented on a distributed system having a plurality of nodes, where each portion of the technology may be located on a different node within the distributed system. In one embodiment of the technology, the node corresponds to a distinct computing device. Alternatively, the node may correspond to a computer processor with associated physical memory. The node may alternatively correspond to a computer processor or micro-core of a computer processor with shared memory and/or resources.

FIGS. 4-6 show flowcharts in accordance with one or more embodiments. While the various blocks in this flowchart are presented and described sequentially, one of ordinary skill will appreciate that at least some of the blocks may be executed in different orders, may be combined or omitted, and at least some of the blocks may be executed in parallel. Furthermore, the blocks may be performed actively or passively. For example, some blocks may be performed using polling or be interrupt driven in accordance with one or more embodiments. By way of an example, determination blocks may not require a processor to process an instruction unless an interrupt is received to signify that condition exists in accordance with one or more embodiments. As another example, determination blocks may be performed by performing a test, such as checking a data value to test whether the value is consistent with the tested condition in accordance with one or more embodiments.

Turning to FIG. 4, in Block 410, various activities are selected for performing an assessment in accordance with one or more embodiments. The activities may be selected by a user input, where a user may determine which activities are available for performing the assessment. In one or more embodiments, a predefined list of activities are associated with a particular type of assessment. Thus, selecting a type of assessment may automatically select which activities may determine the assessment. In one or more embodiments, one type of assessment is a maturity assessment with respect to an oilfield services proposal. In one or more embodiments, the selected activities are used to analyze the quality of the oilfield services proposal, such as the likelihood that the oilfield services proposal is chosen by a recipient who requested the oilfield services proposal. In one or more embodiments, the type of assessment is a skill assessment regarding an oilfield services worker. As such, the selected activities may be chosen for determining the oilfield services worker's experience, work product, and/or any negative behaviors associated with the oilfield services worker.

In Block 420, various activities are identified as having been completed in accordance with one or more embodiments. As such, as various people and/or organizations perform individual activities, a field management tool may receive a notification when an activity is completed. For example, a person responsible for overseeing a particular activity may transmit a message to the central repository that a particular activity is complete. In one or more embodiments, a field management tool may automatically determine the performance of an activity based on monitoring data collected with the field management tool. For example, an activity may be defined using a group of data fields in a database. Thus, when the field management tool obtains data for each data field in the group, the field management tool may determine that the activity has been performed.

In Block 430, various activity scores are computed based on various scoring parameters for various completed activities in accordance with one or more embodiments. In one or more embodiments, an activity score is computed for a particular activity using various parameters, such as component parameter, technical quality parameter, and/or timing attribute. The field management tool may determine which parameters to apply to a particular activity from the activity data and calculate an activity score accordingly. Thus, in one or more embodiments, in regard to a component parameter, activity data may verify what activity was performed and for which project (e.g., with which oilfield services proposal the activity is associated). In one or more embodiments, in regard to a technical quality parameter, activity data may determine who performed the activity (e.g. an author's name on a report or which engineer acquired field samples for a test). In one or more embodiments, in regard to a timing attribute, activity data includes timestamps, e.g., from acquired samples, calendar information for scheduled tasks, and various metadata, such as the date when a document, e.g., a review of a design specification, was transmitted.

In Block 440, an assessment score is computed based on a combination of activity scores in accordance with one or more embodiments. A variety of mathematical functions may be applied to the scores in order to combine the scores without departing from the scope of the invention. For example, the assessment score may be calculated by summing a group of activity scores obtained for the completed activities. In one or more embodiments, different activity scores may be weighted differently as to the amount contributed by the activity score towards the assessment. The assessment score may be a raw number or a vector. For a raw number, each activity score may represent one or more scalar values that are combined to produce a single scalar activity score. For a vector, an activity score may be divided by parameters where each parameter in the activity score has a value. In one or more embodiments, summing the activity scores includes combining the values together for a particular scoring parameter, which produces an assessment score also divided by scoring parameters.

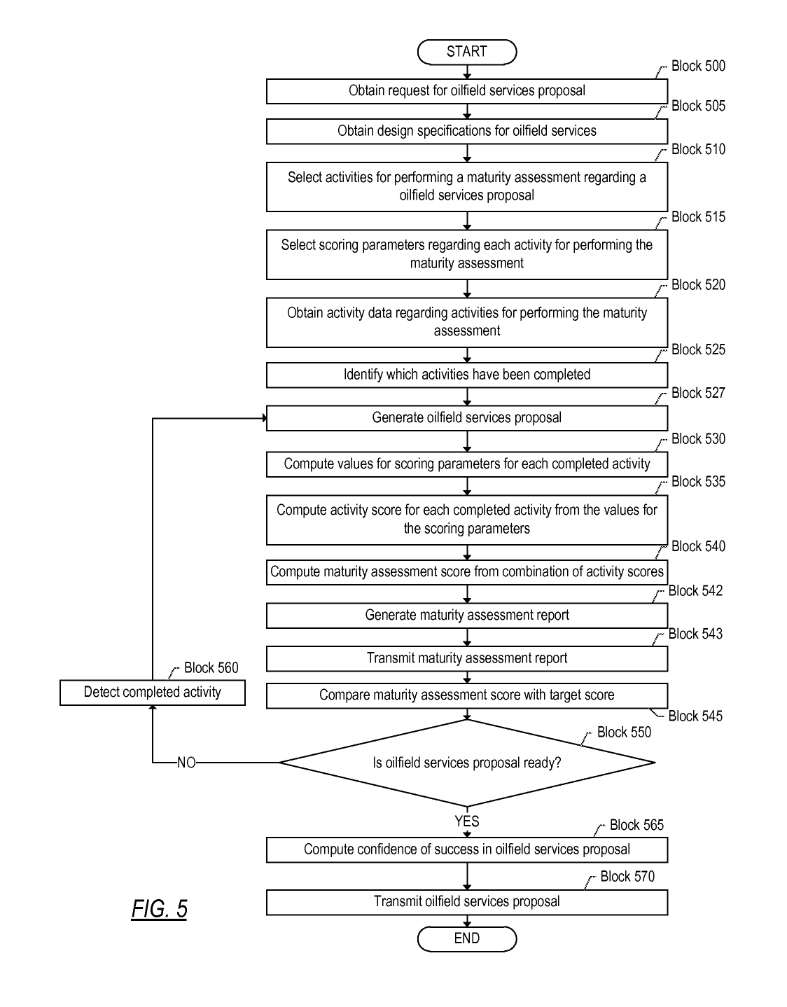

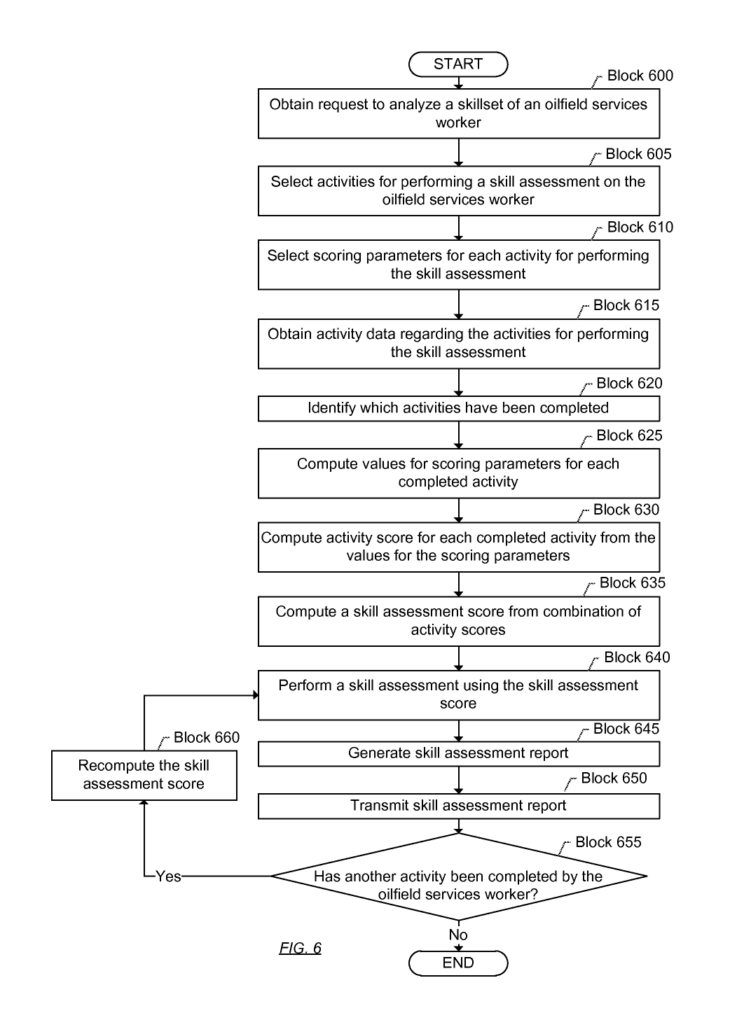

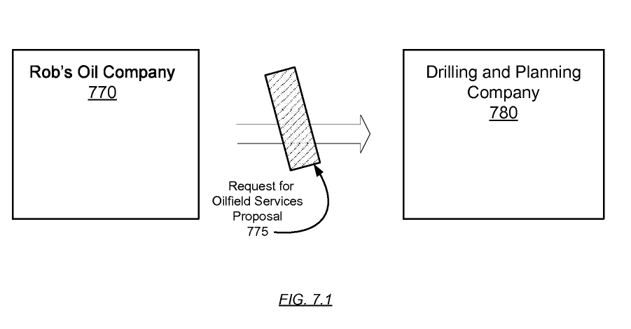

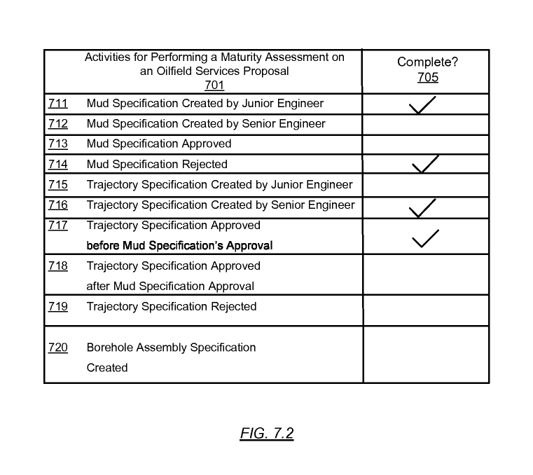

In Block 450, an assessment report is generated using an assessment score in accordance with one or more embodiments. In one or more embodiments, the assessment score is a maturity assessment score as described in FIG. 5 and the accompanying description. As such, the assessment report may describe the progress towards completing the oilfield services proposal as well as potential success of the oilfield services proposal. The assessment report may include information regarding completed activities as well as various parameters associated with each completed activity (e.g., did a junior engineer or a senior engineer complete the activity).

In one or more embodiments, the assessment report is a skill assessment report evaluating a person or group's behavior using a particular skill assessment. As such, the assessment score may be a skill assessment score as described in FIG. 6 and the accompanying description.

In Block 460, an assessment report is transmitted in accordance with one or more embodiments. For example, the assessment report in Block 450 may be transmitted to a user device, such as a computer desktop or a mobile device, where the assessment report may be displayed. The assessment report may be transmitted by a field management tool over a network to one or more designated persons (e.g., a designated email account for a particular person) and/or devices. The assessment report may be transmitted periodically at designated time intervals. In one or more embodiments, the assessment report is transmitted when another activity is completed.

Turning to FIG. 5, in Block 500, a request is obtained for an oilfield services proposal in accordance with one or more embodiments. For example, a client or potential client may submit a request for an oilfield services project. In response to the request, an oilfield services proposal may be generated in Block 527 described below.

In Block 505, design specifications are obtained for oilfield services in accordance with one or more embodiments. For example, the request for the oilfield services proposal in Block 500 may include various design specifications for a particular oilfield services project. In another example, various design specifications may be calculated by an entity generating the oilfield services proposal, e.g., by the contractor seeking to submit a bid, in response to the request in Block 500.

In Block 510, activities are selected for performing a maturity assessment regarding an oilfield services proposal in accordance with one or more embodiments. In one or more embodiments, the selected activities for the maturity assessment change at various stages during the generation of an oilfield services proposal. For example, an oilfield services proposal may be generated through the performance of various activities. In one or more embodiments, the activities are selected according to the design specifications in Block 505.

In one or more embodiments, the maturity assessment is configured for a specific purpose. For example, the specific purpose may include determining whether a proposal is ready to be sent to a client. In another example, the specific purpose may include determining whether a particular team is progressing on generating the oilfield services proposal. In another example, the specific purpose may include determining whether the oilfield services proposal is ready to determine the pricing of various oilfield services.

In one or more embodiments, an activity is selected that verifies a particular property of an oilfield services proposal, such as a trajectory not exceeding a maximum allowable dog leg severity. As such, the activities selected in Block 510 may be finite, while the actual activities completed for producing the oilfield services proposal may be open-ended. In other words, various subsets of the selected activities may be performed to produce the same oilfield services proposal. In one or more embodiments, a selected activity is designated as mandatory for producing the oilfield services proposal.

In Block 515, various scoring parameters are selected regarding each activity for performing a maturity assessment in accordance with one or more embodiments. Each activity may have a predefined set of scoring parameters, or the scoring parameters may be adjusted depending on various design specifications (e.g., a timing attribute for an activity may be tailored to the schedule of the request in Block 500). The scoring parameters may be selected by a producing organization (e.g., the service company) or a consuming organization (e.g., a client). The selection of scoring parameters may allow for the relative nature of activities to be considered in different scoring metrics for calculating a maturity assessment score. In one or more embodiments, the scoring parameters change between different maturity assessments generated while generating the oilfield services proposal.

In Block 520, activity data is obtained in regard to various activities for performing a maturity assessment in accordance with one or more embodiments. In one or more embodiments, for example, activity data is automatically collected by the field management tool when a worker performs one or more tasks associated with the activity with the field management tool. Activity data may be uploaded by oilfield services workers after completing an activity, e.g., uploading a review of a proposed drilling specification.

In Block 525, completed activities are identified in accordance with one or more embodiments. For example, activity data from Block 520 may be analyzed for the performance of a selected activity from Block 510. As such, a completed activity may be identified passively by analyzing data that passes through a field management tool or over a network. Furthermore, an activity may be manually designated as completed (i.e., a person may input that an activity is complete). In one or more embodiments, a designated person transmits a message to a database notifying that a particular activity is complete.

In Block 527, an oilfield services proposal is generated in accordance with one or more embodiments. Thus, a preliminary or final oilfield services proposal may be generated from the completed activities in Block 525.

In Block 530, values for scoring parameters are computed for each completed activity in accordance with one or more embodiments. For example, an activity may have separate point values depending on a technical quality parameter, a timing attribute, or a component parameter. Depending on when the activity was completed and who completed it, different values may be computed for the same activity. The computed values may be an absolute value, e.g., an actual number, or a relative value may be computed. For example, a relative value may adjust a current combined score calculated for the previous completed activities.

In Block 535, activity scores are computed for each completed activity in accordance with one or more embodiments. As such, each completed activity may have a respective activity score calculated from various values as computed in Block 530. The various values may be weighted differently, or an activity score may simply combine each value into a combined activity score. In one or more embodiments, different scoring methods are selected for computing the activity scores as the type of maturity assessment changes throughout generating the oilfield services proposal.

Furthermore, an individual activity score may indicate an increase or decrease in maturity of an oilfield services proposal. In one or more embodiments, an activity score is a negative activity score that decreases the assessed maturity of an oilfield services proposal. For example, a rejection of a trajectory specification may cause several additional activities to be inserted into the selected activities in Block 510. The additional activities may include a mandatory redesign of the trajectory specification or additional mandatory tests on the wellsite. Thus, the rejection has a negative effect on the oilfield services proposal that offsets a positive effect of one or more completed activities. In other words, negative activity scores may reduce the maturity assessment score of an oilfield services proposal to a point lower than if the activities had never been completed. Thereby, the rejection may cause a lower maturity assessment of the oilfield services proposal than previously calculated.

In Block 540, a maturity assessment score is computed from a combination of activity scores in accordance with one or more embodiments. Thus, various activity scores may be combined in a variety of fashions to produce a single, overall score for calculating the maturity assessment score. For example, a design, review, and approval of a trajectory specification may be completed for an oilfield services proposal. Thus, based on various scoring parameters, the design of the trajectory specification may garner 10 points, the review of the trajectory specification may garner 5 points, and the approval of the trajectory specification may garner another 5 points. Thus, with no other activity scores, the maturity assessment score is 20 points when combined.

In one or more embodiments, different activity scores may be assigned different weights in calculating the maturity assessment score. In one or more embodiments, for example, an approval of a trajectory specification is multiplied by the number of reviews of the specification. Using the activity scores from the previous example, the approval garners 5 points. If two more reviews of the trajectory specification occur, the approval of the trajectory specification may garner 15 points.

In one or more embodiments, a repeat performance of an activity may contribute multiple activity scores to the maturity assessment score. For example, a second technical review of a particular design may identify issues that an earlier technical review of the design did not discover, or the second technical review may verify that no issues exist with the design. As such, the maturity assessment score may change accordingly.

In Block 542, a maturity assessment report is generated in accordance with one or more embodiments. The maturity assessment report may describe the status of the oilfield services proposal as computed by the maturity assessment score in Block 540. In one or more embodiments, the maturity assessment report includes an expected date of completion of the oilfield services proposal based on the maturity assessment score computed in Block 540. For example, the maturity assessment report may illustrate how much of the oilfield services proposal is finished or how much remains unfinished using a maturity assessment score.

In Block 543, a maturity assessment report is transmitted in accordance with one or more embodiments. The maturity assessment report may be transmitted by email, as a notification in a graphical user interface (GUI), and/or by any other applicable methods. Thus, the maturity assessment report may be transmitted to a designated entity responsible for administering development on the oilfield services proposal. In one or more embodiments, the maturity assessment report is transmitted to various persons and/or organizations responsible for completing various activities for the oilfield services proposal. As such, different persons and/or organizations may monitor the status in developing the oilfield services proposal using the maturity assessment report.

In one or more embodiments, for example, the maturity assessment report includes an amount of work completed on the oilfield services proposal as well as the amount of work remaining to be completed. In one or more embodiments, the maturity assessment report may predict the schedule date for completing the oilfield services proposal based on a maturity assessment score. Thus, as various activities are completed over time, the maturity assessment score in Block 540 may be recomputed and the status of the oilfield services proposal changes. Thus, with changes to the maturity assessment score, new maturity assessment reports may be generated with each completed activity or at periodic intervals to update various entities on the status of the oilfield services proposal.

Furthermore, a maturity assessment report may provide information for the producers, decision makers and other stakeholders with interest in the oilfield services proposal. In particular, the maturity assessment report may assist in a decision whether to present the oilfield services proposal to a requesting client.

In Block 545, a maturity assessment score is compared with a target score in accordance with one or more embodiments. For example, a target score may be a predetermined point value designating a milestone or a threshold for completion of an oilfield services proposal. As such, the maturity assessment score from Block 540 may be analyzed in relation to the target score for determining an amount of progress towards completing the oilfield services proposal or that the oilfield services proposal is ready for transmission to an entity that requested the oilfield services proposal. In one or more embodiments, multiple target scores are used to track the development of an oilfield services proposal.

In Block 550, a determination is made whether the oilfield services proposal is ready for a specific purpose in accordance with one or more embodiments. With regard to the comparison in Block 545, the oilfield services proposal may be deemed ready when the maturity assessment score is at or above a target score. In one or more embodiments, the determination may be based on a degree of confidence in the success of the oilfield services proposal. For more information on computing the confidence in the success of the oilfield services proposal, see Block 565 below. When it is determined that the oilfield services proposal is ready, the process proceeds to Block 565. When it is determined that the oilfield services proposal is not ready, the process proceeds to Block 560.

In Block 560, a new completed activity is detected in accordance with one or more embodiments. Similar to the manner described with respect to Block 525, one or more additional activities may be identified as being completed in Block 560. As such, the process may proceed to one or more of Blocks 527-545 for generating an oilfield services proposal, and recomputing and/or analyzing an updated maturity assessment score based on the completed activities identified in Block 525 and Block 560.

In Block 565, a confidence of success is computed for the oilfield services proposal in accordance with one or more embodiments. The confidence of success may be computing using technical quality parameters and/or other parameters for various completed tasks. Specifically, activities and parameters of the activities may be compared with oilfield service proposals that were and were not accepted by various requestors. As such, the confidence of success may be a degree of correlation between successful oilfield service proposals and unsuccessful oilfield service proposals. In one or more embodiments, for example, oilfield services proposal based on completed tasks from senior engineers may have a higher confidence of success than if the same completed tasks were performed by junior engineers.

In one or more embodiments, a confidence assessment score is computed in addition to the maturity assessment score. Thus, the confidence assessment score may provide an aggregate assessment score computed similar to the maturity assessment score using various activity scores. Scoring parameters, such as technical quality parameters, may be selected accordingly to compute a confidence of success. In particular, the confidence assessment score may be a combined technical quality parameter score that is compared with combined technical quality parameter scores of successful oilfield service proposals. While Block 565 is shown being performed after the oilfield services proposal is ready in Block 560, the confidence of success may be computed along with various maturity assessments in FIG. 5.

In Block 570, an oilfield services proposal is transmitted in accordance with one or more embodiments. For example, a completed oilfield services proposal may be transmitted to an entity who may distribute the oilfield services proposal to various entities, such as potential clients. In another example, the oilfield services proposal may be transmitted directly to an entity that requested the oilfield services proposal in Block 500.

Turning to FIG. 6, in Block 600, a request is obtained to analyze a skillset of an oilfield services worker in accordance with one or more embodiments. Specifically, a skillset may be objectively measured by assessing a person's individual and/or aggregate skills through an absolute assessment or in relation to other persons, e.g., other oilfield service workers. While FIG. 6 describes a process for assessing a person's skillset, the process may also be applied to assessing a group's performance as well. In one or more embodiments, the assessment analyzes how an individual or group performs various desirable or non-desirable behaviors. Further, while FIG. 6 is directed to assessing the skills of an oilfield services worker, the process may be reconfigured for other types of workers.

In Block 605, activities are selected for performing a skill assessment on an oilfield services worker in accordance with one or more embodiments. The activities may be selected using a manual input. In one or more embodiments, various activities are associated with a particular type of job. Thus, activities may be automatically selected by a field management tool that are performed by a worker assigned to the type of job. For example, if the worker is an engineer, welder, laborer, construction worker, etc., various activities may be selected accordingly.

Specifically, the skill assessment may determine the maturity of a worker for a particular job, the amount of experience of the worker, and various positive and/or negative behaviors of the worker. As such, the skill assessment may determine whether an oilfield services worker is capable of performing various tasks.

In Block 610, scoring parameters are selected for each activity for analyzing the skillset in accordance with one or more embodiments. The scoring parameters may include timing attributes, component parameters, and technical quality parameters for determining a worker's maturity at a particular job. As such, the scoring parameters may determine a worker's degree of experience at performing a particular task associated with a job as well as the worker's proficiency at the task.

In Block 615, activity data is obtained regarding the activities for performing the skill assessment in accordance with one or more embodiments. Activity data may be collected in Block 615 similar to how completed activity data is collected in Block 520.

In Block 620, completed activities are identified in accordance with one or more embodiments. Completed activities may be identified in Block 620 similar to how completed activities are identified in Block 525. As such, completed activities may be identified using activity data from Block 615.

In Block 625, values for scoring parameters are computed for each completed activity in accordance with one or more embodiments. Values may be computed in Block 625 similar to how values are computed in Block 530.

In Block 630, activity scores are computed for each completed activity in accordance with one or more embodiments. Activity scores may be computed in Block 630 similar to how activity scores are computed in Block 535.

In Block 635, a skill assessment score is computed from a combination of activity scores in accordance with one or more embodiments. Thus, various activity scores may be combined in a variety of fashions to produce a single, overall score for the skill assessment score. Furthermore, the skill assessment score may be computed similar to the maturity assessment score in Block 540.

In Block 640, a skill assessment is performed using the skill assessment score in accordance with one or more embodiments. In one or more embodiments, the assessment provides encouragement and motivation for an individual or a group to perform various desired behaviors by making the assessment of the individual's or group's visible to the assessed individual. As such, the skill assessment score may be compared to a target score that describes various stages of experience and/or capability for a particular type of worker.

In Block 645, a skill assessment report is generated in accordance with one or more embodiments. In one or more embodiments, the skill assessment report describes the oilfield services worker's maturity at performing a particular job. Thus, the skill assessment report may highlight areas of improvement and/or areas of commendation for the oilfield services worker. In one or more embodiments, the skill assessment report compares the skill assessment score of a particular oilfield services worker with skill assessment scores of other oilfield service workers.

In Block 650, the skill assessment report is transmitted in accordance with one or more embodiments. The skill assessment report may be the skill assessment report in Block 645. In one or more embodiments, the skill assessment report may be transmitted to a user device associated with the oilfield services worker who was the target of the skill assessment. Thus, the skill assessment report may provide the oilfield services worker with motivation to perform activities that would increase their skill assessment score. In one or more embodiments, the skill assessment report is transmitted to an email address associated with the oilfield service worker's supervisor.

In Block 655, a determination is made whether another activity has been completed by the oilfield services worker in accordance with one or more embodiments. In one or more embodiments, the field management tool uses activity data to detect another completed activity for a skill assessment. When it is determined that another activity has been completed, the process proceeds to Block 660. When no other activity is determined as being complete, the process ends.

In Block 660, the skill assessment score is recomputed in accordance with one or more embodiments. As such, additional activity scores may be computed for any completed activities not included in computing the previous skill assessment score. As such, the process may proceed to Block 640 to compute a new skill assessment score using the additional activity scores.

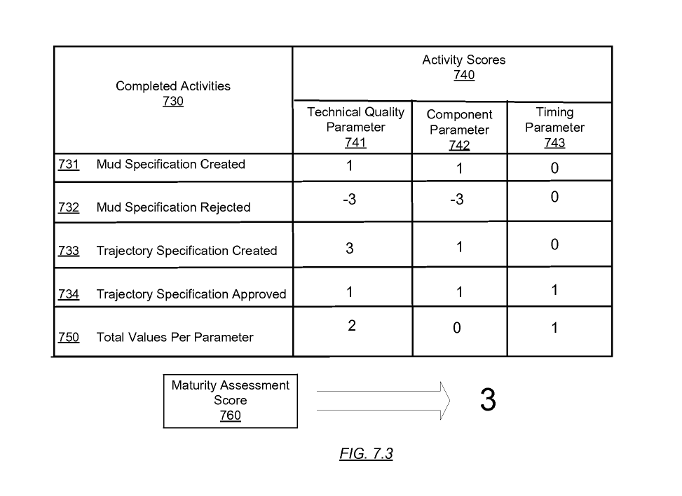

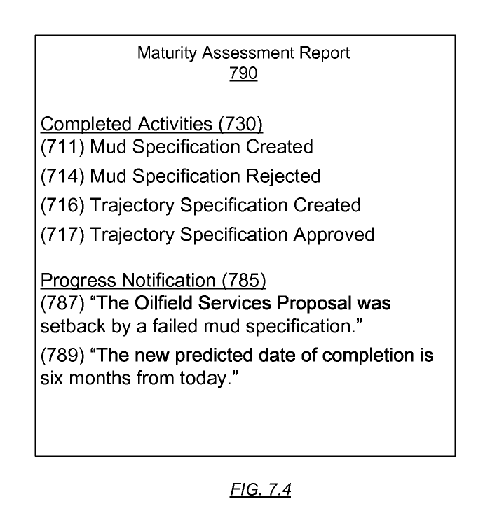

FIGS. 7.1, 7.2, and 7.3 provide an example of computing a maturity assessment score. The following example is for explanatory purposes only and not intended to limit the scope of the technology. Turning to FIG. 7.1, Rob's Oil Company (770) owns the mineral rights to a hydrocarbon reservoir. Thus, Rob's Oil Company (770) decides to drill a new well on an area of land above the hydrocarbon reservoir. Rob's Oil Company (ROC) (770) sends a request for an oilfield services proposal (775) to Drilling and Planning Company (DPC) (780). In order to draft the oilfield services proposal, DPC (780) selects several activities for preparation of drilling, which are shown in FIG. 7.2 under the column for “Activities for Performing a Maturity Assessment on an Oilfield Services Proposal” (701). The selected activities include a “Mud Specification Created by a Junior Engineer” (711), “Mud Specification Created by a Senior Engineer” (712), “Mud Specification Approved” (713), “Mud Specification Rejected” (714), “Trajectory Specification Created by Junior Engineer” (715), “Trajectory Specification Created by Senior Engineer” (716), “Trajectory Specification Approved after Mud Specification's Approval” (717), “Trajectory Specification Approved before Mud Specification's Approval” (718), “Trajectory Specification Rejected” (719), and “Borehole Assembly Specification Created” (720).

Furthermore, DPC (780) identifies various completed activities for the oilfield services proposal, which are located in the column designated as “Completed?” (705) using check marks. Turning to FIG. 7.3, DPC (780) computes a Maturity Assessment Score (760) based on the completed activities in FIG. 7.2. As shown in FIG. 7.3, the Completed Activities (730) include “Mud Specification Created” (731), “Mud Specification Rejected” (732), “Trajectory Specification Created” (733), and “Trajectory Specification Approved” (734). Activity Scores (740) for the Completed Activities (730) are separated by parameter values into various scoring parameters (i.e., technical quality parameter (741), component parameter (742), and a timing parameter (743)). Thus, the “Mud Specification Rejected” (732) activity produces a technical quality parameter with a ‘−3’ value and a component parameter with a ‘−3’ value. The row designated “Total Values” (750) illustrated the combined values from the Activity Scores (740) for each parameter. Here, the Maturity Assessment Score (760) is computed as a raw scalar score having a combined value of ‘3’. In another embodiment, the Maturity Assessment Score (760) may be a vector separated by parameters similar to the breakdown of the “Total Values Per Parameter” (750).

Turning to FIG. 7.4, a Maturity Assessment Report (790) is shown based on the Maturity Assessment Score (760) from FIG. 7.3. The Maturity Assessment Report (790) includes the Completed Activities (730) from FIG. 7.2 and a Progress Notification (785). The Progress Notification (785) includes information about one of the Completed Activities (730) (i.e., “The Oilfield Services Proposal was setback by a failed mud specification.” (787)) and information regarding the status of the oilfield services proposal (i.e., “The new predicted date of completion is six months from today.” (789)).

While the technology has been described with respect to a limited number of embodiments, those skilled in the art, having benefit of this disclosure, will appreciate that other embodiments can be devised which do not depart from the scope of the technology as disclosed herein. Accordingly, the scope of the technology should be limited only by the attached claims.

What is claimed is:

1. A method, comprising:
obtaining activity data regarding a plurality of activities relating to an oilfield services proposal, wherein the activity data describes the performance of at least a portion of the activity;
identifying, using the activity data, a completed activity from the plurality of activities;
computing, using a scoring parameter, an activity score, wherein the scoring parameter determines the activity score based on a contribution of the completed activity towards the oilfield services proposal;
computing an assessment score based on the activity score; and
generating, using the assessment score, a report regarding progress made towards the oilfield services proposal.

2. The method of claim 1, further comprising:
comparing the assessment score to a target score to determine the progress made towards the oilfield services proposal, and
wherein the target score designates a threshold for completing the oilfield services proposal.

3. The method of claim 1, wherein the completed activity comprises a plurality of completed activities, and further comprising:
computing a first activity score for a first completed activity from the plurality of completed activities; and
computing a second score for a second completed activity from the plurality of completed activities, and
wherein computing the assessment score comprises combining the first score and the second score to produce the assessment score.

4. The method of claim 3, wherein the first activity score is computed based on a technical quality parameter of a person that performs the first completed activity.

5. The method of claim 3, wherein computing the first activity score comprises decreasing the first activity score when the second completed activity is performed before the first completed activity.

6. The method of claim 1,
wherein computing the assessment score comprises reducing the assessment score by a negative activity score.

7. The method of claim 1, further comprising:
computing a confidence of success in the oilfield services proposal based on the completed activity.

8. The method of claim 1, wherein the completed activity is identified automatically by a field management tool that collects information regarding the oilfield services proposal.

9. The method of claim 1,
wherein the oilfield services proposal is divided into a plurality of portions, and
wherein the contribution is a percentage of the plurality of portions produced by the completed activity.

10. A system, comprising:
a data repository for storing:
activity data regarding a plurality of activities for an oilfield services proposal; and
a plurality of scoring parameters configured to determine a plurality of activity scores based on a contribution of a plurality of completed activities towards the oilfield services proposal; and
a computer processor, coupled to the data repository, for executing a module, the module configured to:
select the plurality of activities;
obtain the activity data regarding the plurality of activities, wherein the activity data describes the performance of one or more of the plurality of activities;
compute an assessment score based on the plurality of activity scores; and
generate, using the assessment score, a report regarding progress made towards the oilfield services proposal.

11. The system of claim 10, wherein the module is further configured to:
compute a first activity score for a first completed activity from the plurality of completed activities; and
compute a second activity score for a second completed activity from the plurality of completed activities, and wherein computing the assessment score comprises combining the first activity score and the second activity score to produce the assessment score.

12. The system of claim 11, wherein the first activity score is computed based on a technical quality parameter of a person that performs the first completed activity.

13. The system of claim 11, wherein the module is further configured to decrease the first activity score when the second completed activity is performed before the first completed activity.

14. The system of claim 11, wherein the module is further configured to compute a confidence of success in the oilfield services proposal based on the plurality of completed activities.

15. A non-transitory computer readable medium storing instructions, the instructions, when executed by a computer processor, comprising functionality for:
computing, using a scoring parameter, an activity score from a completed activity relating to an oilfield services proposal, wherein the scoring parameter determines the activity score based on a contribution of the completed activity towards the oilfield services proposal;
computing an assessment score based on the activity score; and
generating, using the assessment score, a report regarding progress made towards the oilfield services proposal.

16. The non-transitory computer readable medium of claim 15, wherein the completed activity comprises a plurality of completed activities, and the instructions further comprise functionality for:
computing a first activity score for a first completed activity from the plurality of completed activities; and
computing a second activity score for a second completed activity from the plurality of completed activities, and
wherein computing the assessment score comprises combining the first score and the second score to produce the assessment score.

17. The non-transitory computer readable medium of claim 16, wherein the first activity score is computed based on a technical quality parameter of a person that performs the first completed activity.

18. The non-transitory computer readable medium of claim 16, wherein computing the first activity score comprises decreasing the first activity score when the second completed activity is performed before the first completed activity.

19. The system of claim 15, wherein the instructions further comprise functionality for:
computing a confidence of success in the oilfield services proposal based on the completed activity.

20. A method, comprising:
obtaining activity data regarding an activity, wherein the activity data describes the performance of an oilfield services worker in performing the activity;
computing, using a scoring parameter, an activity score, wherein the scoring parameter determines the activity score based on a degree of experience of the oilfield services worker at performing a predetermined job; and
computing a first score based on the activity score;
generating, using the first score, a report regarding progress made by the oilfield services worker towards performing the predetermined job.
